(19) United States
(12) Patent Application Publication
(10) Pub. No.: US 2005/0125582 A1
(43) Pub. Date: Jun. 9, 2005

(54) Methods and apparatus to dispatch interrupts in multi-processor systems

(76) Inventors: Steven J. Tu, Phoenix, AZ (US); Samantha J. Edirisooriya, Tempe, AZ (US); Sujat Jamil, Chandler, AZ (US); David E. Miner, Chandler, AZ (US); R. Frank O'Bleness, Tempe, AZ (US); Hang T. Nguyen, Tempe, AZ (US)

Correspondence Address: GROSSMAN & FLIGHT LLC, Suite 4220, 20 North Wacker Drive, Chicago, IL, 60606-6357, US

(21) Appl. No.: 10/730,467

(22) Filed: Dec. 8, 2003

(51) Int. Cl. G06F 13/24

(52) U.S. Cl. 710/260

(57) ABSTRACT

Methods and apparatus to dispatch interrupt requests in multi-processor systems are disclosed. In an example method, an interrupt weighted average (IWA) of each of a plurality of processors is generated based on interrupt dispatch information associated with the plurality of processors. Based on the IWA of each of the plurality of processors, a target processor from the plurality of processors is identified to dispatch an interrupt.

### TECHNICAL FIELD

The present disclosure relates generally to multi-processor systems, and more particularly, to methods and apparatus to dispatch interrupts in multi-processor systems.

### BACKGROUND

In a processor system, an interrupt is an event that may be triggered by either an input/output (I/O) device coupled to the processor system or a program within the processor system that causes the main program controlling the operation of the processor system (i.e., the operating system (OS)) to stop a current task(s) and perform some other task(s). When a network device detects an incoming packet, the network device may send an interrupt to the processor. In response to the interrupt, the processor initiates an interrupt routine. For example, a video decoder may send an interrupt to a processor to request error handling services from the processor in response to detecting an error in a video packet stream.

Typically, an interrupt controller prioritizes the interrupts and to save the interrupts in a queue waiting to be processed. In current processor systems employing multi-threaded cores, multi-core processors, multi-tasked cores, and/or virtualized cores (i.e., a virtual multi-processor system), interrupts may be dispatched or routed to a target processor that is executing a priority task and/or application and, as a result, may cause the entire multi-processor system to operate inefficiently. With fixed redirection schemes or simple arbitrary schemes such as a round-robin scheme, interrupts often cause sub-optimal performance by processing resources to execute tasks and/or applications.

### BRIEF DESCRIPTION OF THE DRAWINGS

FIG. 1 is a block diagram representation of an example interrupt dispatch system configured in accordance with the teachings of the invention.

FIG. 2 is a block diagram representation of an example multi-processor programmable interrupt controller (MPIC) that may be used to implement the example interrupt dispatch system of FIG. 1.

FIG. 3 is a flow diagram representation of example machine readable instructions that may be executed to implement the example interrupt dispatch system of FIG. 1.

FIG. 4 is a block diagram representation of an example processor system that may be used to implement the example MPIC of FIG. 2.

### DETAILED DESCRIPTION

Although the following discloses example systems including, among other components, software or firmware executed on hardware, it should be noted that such systems are merely illustrative and should not be considered as limiting. For example, it is contemplated that any or all of the disclosed hardware, software, and/or firmware components could be embodied exclusively in hardware, exclusively in software, exclusively in firmware or in some combination of hardware, software, and/or firmware.

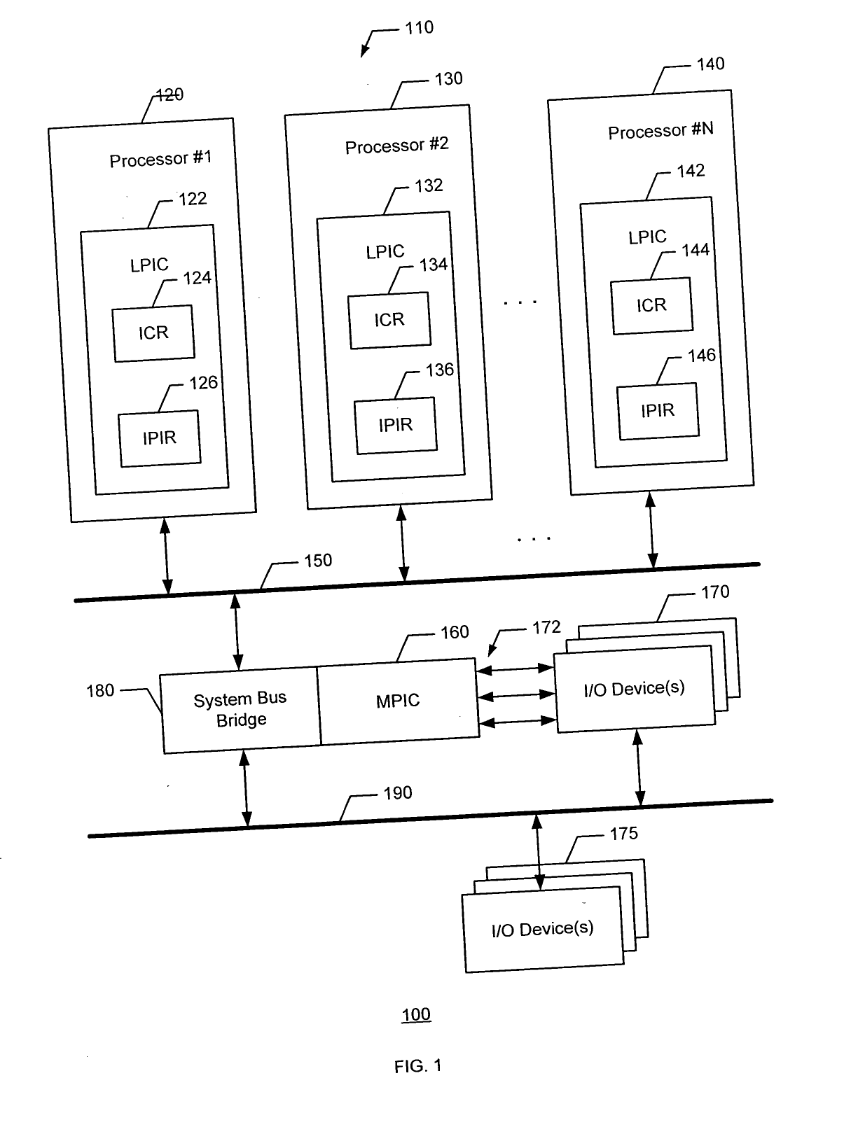

In the example of FIG. 1, the illustrated interrupt dispatch system 100 includes a plurality of processors 110, generally shown as Processors.#1 through N 120, 130, and 140, respectively. Each of the plurality of processors 110 includes a local programmable interrupt controller (LPIC), generally shown as 122, 132, and 142. Each of the LPICs 122, 132, and 142 includes an inter-processor interrupt register (IPIR), generally shown as 124, 134, and 144, and an interrupt control register (ICR), generally shown as 126, 136, and 146. The LPICs 122, 132, and 142 handle pending interrupts, masking, prioritization, and vector generation as persons of ordinary skill in the art will readily recognize. In particular, the LPICs 122, 132, and 142 (e.g., via the ICRs 126, 136, and 146, respectively) receive and process inter-processor interrupt (IPI) messages for the cores of the plurality of processors 110 to execute. The LPICs 122, 132, and 142 (e.g., via the IPIRs 124, 134, and 144, respectively) also generate IPI messages to enable the plurality of processors 110 to communicate with each other.

The illustrated interrupt dispatch system 100 also includes a system bus 150, and a multi-processor programmable interrupt controller (MPIC) 160. As described herein, the MPIC 160 prioritizes interrupts, balances interrupt load, and/or generates IPI messages to a system bus bridge 180. In general, the MPIC 160 receives pin-based and/or signal-based interrupts from input/output (I/O) devices, generally shown as 170 and 175, such as a mouse, a keyboard, a display, a printer, a disk drive, and/or any other peripherals. To send a pin-based interrupt, the I/O device 170 is coupled directly to the MPIC 160 via a set of interrupt input pins 172. Each of the interrupt input pins 172 corresponds to a particular type of interrupt (e.g., a read interrupt or a write interrupt). For example, when a printer completes a print job, the printer may generate an interrupt to the MPIC 160. In another example, when a disk drive completes reading and/or writing to a disk, the disk drive may generate an interrupt to the MPIC 160. Based on the type of interrupt, the I/O device 170 may send an interrupt to the MPIC 160 via one of the set of interrupt input pins 172. In accordance with system bus protocol(s), the system bus bridge 180 initiates interrupt messaging between the plurality of processors 110 and the MPIC 160 via the system bus 150. That is, the system bus bridge 180 enables transmission of inter-processor interrupt (IPI) messages to the plurality of processors 110 so that the interrupts may be dispatched by the MPIC 160 and processed by the plurality of processors 110. Thus, the MPIC 160 may dispatch the interrupt to at least one of the plurality of processors 110 (i.e., a target processor) by generating an IPI message to the system bus bridge 180 in accordance with an interrupt load balancing policy as described herein. To implement the interrupt load balancing policy, the MPIC 160 identifies the target processor from the plurality of processors 110 to dispatch the interrupt based on one or more interrupt load balancing parameters such as time (e.g., interrupt service age level), history (e.g., interrupt loading history level), and availability (e.g., interrupt availability level) of the plurality of processors 110.

To send a signal-based interrupt to the MPIC 160, the I/O device 175 is coupled to the MPIC 160 via the system bus bridge 180 and an I/O bus 190. In contrast to sending the interrupt to the MPIC 160 via one of the set of interrupt input pins 172, the I/O device 175 sends an interrupt message to the system bus bridge 180 via the I/O bus 190. Persons of ordinary skill in the art will readily appreciate that the interrupt message indicates the type of interrupt requested by the I/O device 175 (e.g., a read interrupt or a write interrupt). Accordingly, the MPIC 160 generates an IPI message corresponding to the interrupt message from the I/O device 175, and dispatches the interrupt to the target processor based on the interrupt load balancing policy via the IPI message.

While the interrupts dispatched by the interrupt dispatch system 100 of FIG. 1 are described above as hardware interrupts (e.g., an interrupt from a printer), the interrupts may be software interrupts (e.g., an interrupt from a word-processing application). In one particular example, a software interrupt may occur when an application ends and/or requests for instruction(s) from the operating system (OS) (not shown).

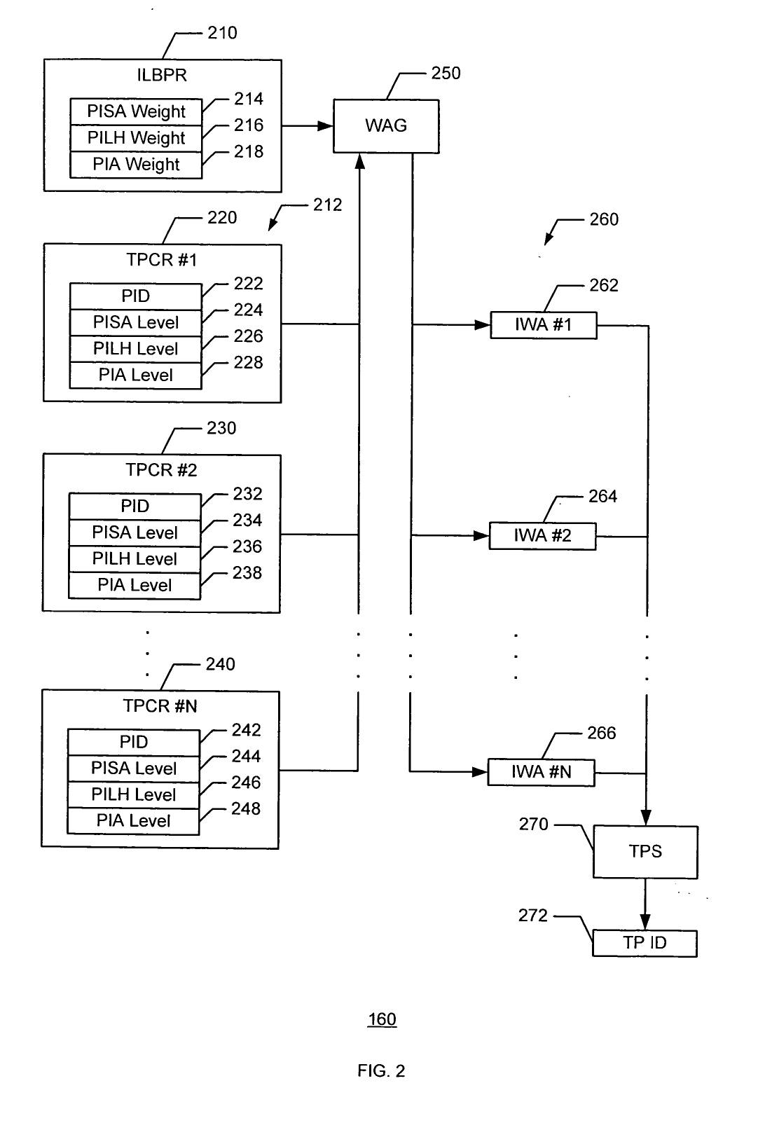

In the example of FIG. 2, the illustrated MPIC 160 includes an interrupt load balancing policy register (ILBPR) 210, a plurality of target processor control registers (TPCRS) 212, a weighted average generator (WAG) 250, and a target processor selector (TPS) 270. The ILBPR 210 includes weights for one or more interrupt load balancing parameters such as processor interrupt service age (PISA), processor interrupt loading history (PILH), and processor interrupt availability (PIA) to implement the interrupt load balancing policy. The PISA parameter indicates the time that interrupts have been queued up the plurality of processors 110 (i.e., how long do interrupts wait before being processed by each of the plurality of processors 110). The PILH parameter indicates a history of interrupts dispatched to the plurality of processors 110 (i.e., how often interrupts are dispatched to each the plurality of processors 110 in executing other task(s)). The PIA parameter indicates the willingness of the plurality of processors 110 to receive interrupts from the MPIC 160 (i.e., how busy is each of the plurality of processors 110).

Each of the interrupt load balancing parameters is assigned a relative weight to indicate the relative importance/influence of that particular parameter in the interrupt load balancing policy. For example, the ILBPR 210 may include a PISA weight 214, a PILH weight 216, and a PIA weight 218. If the interrupt load balancing parameters are equally important to the interrupt load balancing policy, each of the interrupt load balancing parameters is assigned to an identical weight. However, if a particular interrupt load balancing parameter is relatively more important than another parameter, then that particular interrupt load balancing parameter may be associated with a greater weight. To illustrate one manner in which relative weights may be assigned to each of the interrupt load balancing parameters, the PISA weight 214 may be a relative weight of two and the PILH weight 216 may also be a relative weight of two, but the PIA weight 218 may be a relative weight of one. The PISA parameter and the PILH parameter are equally important in this example interrupt load balancing policy because the PISA weight 214 and the PILH weight 216 have an identical weight of two. In addition, in this example, the PISA parameter and the PILH parameter are relatively more important than the PIA parameter because both the PISA weight 214 and the PILH 216 weight have a relative weight that is twice as the PIA weight 218.

The PISA weight 214, the PILH weight 216, and the PIA weight 218 may be changed to support other interrupt load balancing schemes. To implement a round-robin scheme, for example, the PISA weight 214 and the PIA weight 218 may be set to the lowest level (e.g., zero) so that the interrupt load balancing policy is based solely on the PILH parameter (i.e., the PILH weight 216 is greater than the PISA weight 214 and the PIA weight 218). Thus, the MPIC 160 may simply dispatch interrupts in a sequential order starting from Processor #1 120 to Processor #N 140, and then repeat the order.

While the weights of the interrupt load balancing parameters are described in a particular range, the weights of the interrupt load balancing parameters may be implemented by any other suitable range to indicate the importance-of each of the interrupt load balancing parameters relative to each other in the interrupt load balancing policy.

As noted above, the MPIC 160 also includes the plurality of TPCRs 212, generally shown as TPCR #1 220, TPCR #2 230, and TPCR #N 240, that include interrupt dispatch information associated with the plurality of processors 110. Each of the plurality of TPCRs 212 corresponds to one of the plurality of processors 110 of the example interrupt dispatch system 100. For example, TPCR #1 220 corresponds to Processor #1 120, TPCR #2 230 corresponds to Processor #2 130, and TPCR #N 240 corresponds to Processor #N 140. Each of the plurality of TPCRs 212 includes interrupt dispatch information associated with its corresponding processor. In each of TPCRs 212, the interrupt dispatch information identifies a particular processor, and indicates the level of that particular processor in each of the interrupt load balancing parameters of the ILBPR 210. In particular, each of the plurality of TPCRs 212 includes a processor identifier (PID), a PISA level, a PILH level, and a PIA level. For example, the TPCR #1 220 includes the PID 222, the PISA level 224, the PILH level 226, and the PIA level 228 associated with Processor #1 120. The PID 222 may be an identification number corresponding to Processor #1 120. The PISA level 224 indicates the time spent by Processor #1 120 on processing interrupts. The PILH level 226 indicates the history of interrupts dispatched to Processor #1 120 (i.e., how many interrupts have been dispatched to Processor #1 120). The PIA level 228 indicates the availability of Processor #1 120 to execute interrupts from the MPIC 160 (i.e., how busy is Processor #1 120). For example, the interrupt dispatch system 100 may dedicate important task(s) to Processor #1 120 to execute, and lower the PIA level 228 to reduce the willingness of Processor #1 120 to accept interrupts from the MPIC 160. Alternatively, the interrupt dispatch system 100 may simply set the PIA level 228 to the lowest level (e.g., zero) so that Processor #1 120 is always unavailable to receive interrupts from the MPIC 160. Thus, Processor #1 120 may concentrate on performing the important task previously assigned by the interrupt dispatch system 100. In a similar manner as TPCR #1 220, TPCR #2 230 includes the PID 232, the PISA level 234, the PILH level 236, and the PIA level 238 associated with Processor #2 130, and TPCR #N 240 includes the PID 242, the PISA level 244, the PILH level 246, and the PIA level 248 associated with Processor #N 140.

To identify one of the plurality of processors 110 as a target processor to process an interrupt, the WAG 250 determines interrupt weighted averages (IWAs) 260, generally shown as IWA #1 262, IWA #2 264, and IWA #N 266, for each of the plurality of processors 110. Based on the weights of the interrupt load balancing parameters 214, 216, 218 and the interrupt dispatch information stored in the plurality of TPCRs 212, the WAG 250 calculates the IWAs 260. The WAG 250 may use various methods to evaluate ILBPR 210 and TPCRs 212. For example, these methods may include a full-bit range computation of the IWA for each of the plurality of processors 110 to select the least loaded processor, and a comparison based on one of the three levels of the interrupt dispatch information. The WAG 250 calculates IWA #1 262 by weighting (e.g., multiplying) the PISA level 224, the PILH level 226, and the PIA level 228 of Processor #1 120 according to the PISA weight 214, the PILH weight 216, and the PIA weight 218, respectively. That is, the WAG 250 multiples the PISA level 224 to the PISA weight 214, the PILH 226 to the PILH weight 216, and the PIA level 228 to the PIA weight 218, and adds the resulting products together to generate IWA #1 262. Likewise, the WAG 250 calculates IWA #2 264 by weighing the PISA level 234, the PILH level 236, and the PIA level 238 of Processor #2 130 according to the PISA weight 214, the PILH weight 216, and the PIA weight 218, respectively. In a similar manner, the WAG 250 calculates IWA #N 266 with the PISA level 244, the PILH level 246, and the PIA level 248 of Processor #N 140.

Upon calculating the IWAs 260 by the WAG 250, the TPS 270 compares the IWAs 260 of the plurality of processors 110 to select one of the plurality of processors 110 as the target processor for receiving/servicing a next interrupt. For example, the TPS 270 may identify the processor associated with the highest IWA as the target processor. In that case, the MPIC 160 dispatches the interrupt to the target processor to execute by generating an IPI message to the target processor identifier (TPID) 262 of the target processor.

While the PISA, PILH, and PIA parameters shown in FIG. 2 are particularly well suited for implementation of the interrupt dispatch system 100, persons of ordinary skill in the art will readily appreciate that other suitable interrupt load balancing parameters may be used. Further, one or more of the interrupt load balancing parameters described herein may be disabled to identify the target processor. To implement a time round-robin scheme (e.g., an interrupt is dispatched to each of the plurality of processors 110 regardless of any other reasons), for example, the interrupt dispatch system 100 may set the PISA weight 214 and the PIA weight 218 to the lowest level (e.g., zero) so that the WAG 250 may calculate the IWAs 260 solely based on the PILH parameter. As a result, the MPIC 160 may simply dispatch interrupts in a sequential order starting from, for example, Processor #1 120 to Processor #N 140, and then repeat the order.

In contrast to well-known fixed-redirection schemes, the MPIC 160 provides a dynamic or time-variant interrupt dispatch/routing scheme by identifying a target processor (i.e., the least loaded processor) based on the interrupt load balancing parameters. By identifying the target processor to handle an interrupt, other processors may focus on executing their corresponding program threads. Further, the MPIC 160 provides flexibility to adjust the relative importance of interrupt load balancing parameters. Thus, the overall system performance of the interrupt dispatch system 100 may be improved and optimized.

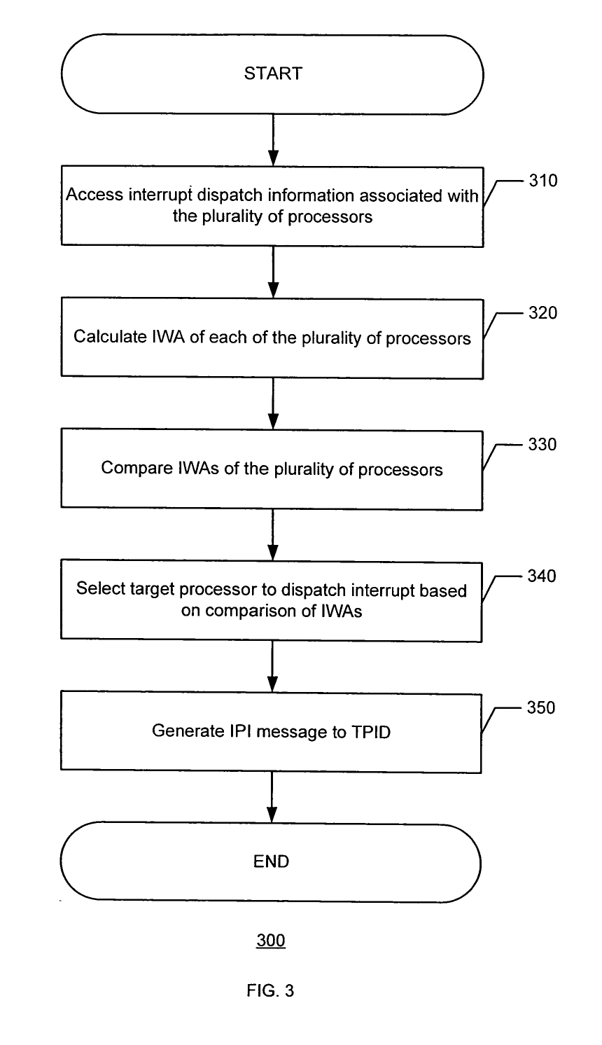

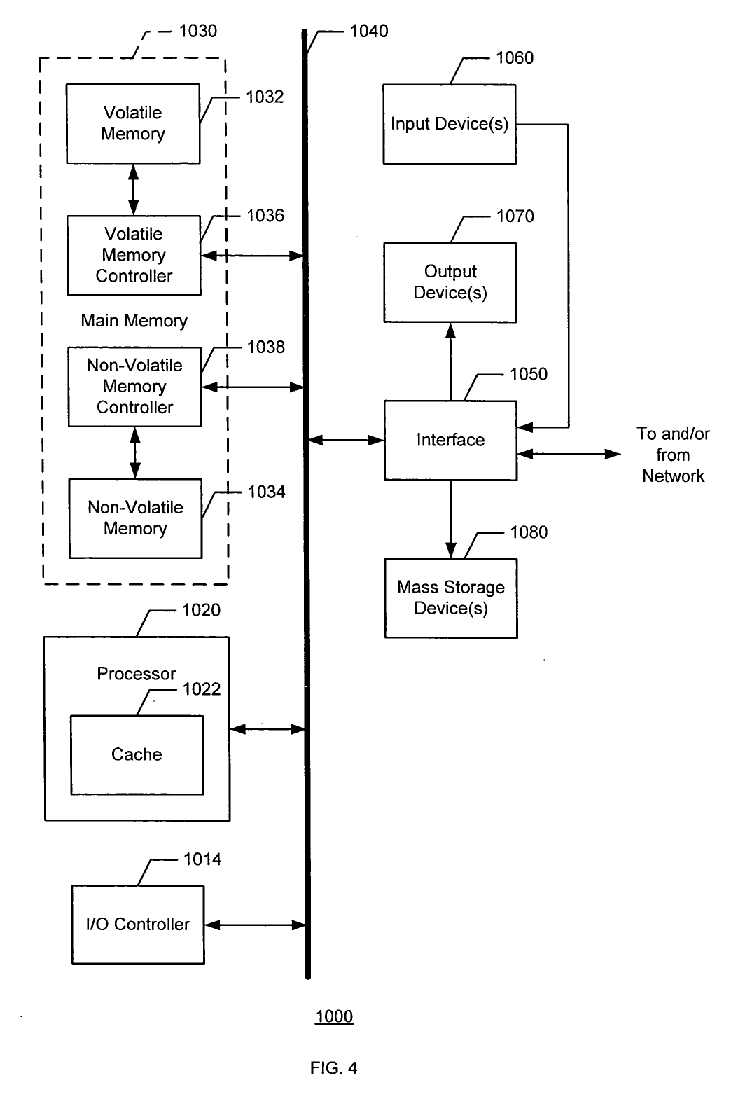

FIG. 3 is a flow diagram 300 representing one manner in which the MPIC 160 of FIG. 2 may control the dispatch of interrupts in multi-processor systems. Persons of ordinary skill in the art will appreciate that the flow diagram 300 of FIG. 3 may be implemented using machine readable instructions that are executed by a processor system (e.g., the processor system 1000 of FIG. 4). In particular, the instructions may be implemented in any of many different ways utilizing any of many different programming codes stored on any of many machine readable mediums such as a volatile or nonvolatile memory or other mass storage device (e.g., a floppy disk, a CD, and a DVD). For example, the machine readable instructions may be embodied in a machine-readable medium such as an erasable programmable read only memory (EPROM), a read only memory (ROM), a random access memory (RAM), a magnetic media, an optical media, and/or any other suitable type of medium. Alternatively, the machine readable instructions may be embodied in a programmable gate array and/or an application specific integrated circuit (ASIC). Further, although a particular order of actions is illustrated in FIG. 3, persons of ordinary skill in the art will appreciate that these actions can be performed in other temporal sequences. Again, the flow diagram 300 is merely provided as an example of one way to dispatch interrupts in multi-processor systems.

The flow diagram 300 begins with the WAG 250 accessing interrupt dispatch information associated with each of the plurality of processors 110 (block 310). For example, the WAG 250 accesses TPCRs 212 for the PID, the PISA level, the PILH level, and the PIA level of each of the plurality of processors 110. Based on one or more interrupt load balancing parameters specified by the interrupt load balancing policy of the ILBPR 210, the WAG 250 determines an IWA of each of the plurality of processors 110 (block 320). As noted above, the WAG 250 calculates the IWAs 260 of the plurality of processors 110 based on the PISA level, the ILH level, and PIA level of each of the plurality of processors 110. For example, the WAG 250 calculates the IWA #1 262 of Processor #1 120 based on the PISA level 224, PILH level 226, and the PIA level 228. Each of the PISA level 224, the ILH level 226, and the PIA level 228 are factored into the IWA #1 262 based on the interrupt load balancing policy, which indicates the relative weight of the PISA, PILH, and the PIA parameters. Upon calculating the IWAs 260 of the plurality of processors 110 by the WAG 250, the TPS 270 compares the IWAs 260 (block 330). Based on the comparison of the IWAs 260, the TPS 270 selects one or more of the plurality of the processors 110 as the target processor to which the MPIC 160 will dispatch a next interrupt (block 340). For example, the TPS 270 may select a particular processor from the plurality of processors 110 as the target processor because that particular processor is associated with the highest IWA. Accordingly, the TPS 270 dispatches the interrupt to the target processor by generating an IPI message to the TPID corresponding to the target processor (block 350). As a result, the MPIC 160 improves system performance by dispatching interrupts to the plurality of processors 110 in accordance with the interrupt load balancing policy.

FIG. 4 is a block diagram of an example processor system 1000 adapted to implement the methods and apparatus disclosed herein. The processor system 1000 may be a desktop computer, a laptop computer, a notebook computer, a personal digital assistant (PDA), a server, an Internet appliance or any other type of computing device.

The processor system 1000 illustrated in FIG. 4 provides memory and I/O management functions, as well as a plurality of general purpose and/or special purpose registers, timers, etc. that are accessible or used by a processor 1020. The processor 1020 is implemented using one or more processors. For example, the processor 1020 may be implemented using one or more of the Intel® Pentium® technology, the Intel® Itanium® technology, Intel® Centrino® technology, and/or the Intel® XScale® technology. In the alternative, other processing technology may be used to implement the processor 1020. The processor 1020 includes a cache 1022, which may be implemented using a first-level unified cache (L1), a second-level unified cache (L2), a third-level unified cache (L3), and/or any other suitable structures to store data as persons of ordinary skill in the art will readily recognize.

As is conventional, the volatile memory controller 1036 and the non-volatile memory controller 1038 perform functions that enable the processor 1020 to access and communicate with a main memory 1030 including a volatile memory 1032 and a non-volatile memory 1034 via a bus 1040. The volatile memory 1032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 1034 may be implemented using flash memory, Read Only Memory (ROM), Electrically Erasable Programmable Read Only Memory (EEPROM), and/or any other desired type of memory device.

The processor system 1000 also includes an interface circuit 1050 that is coupled to the bus 1040. The interface circuit 1050 may be implemented using any type of well known interface standard such as an Ethernet interface, a universal serial bus (USB), a third generation input/output interface (3GIO) interface, and/or any other suitable type of interface.

One or more input devices 1060 are connected to the interface circuit 1050. The input device(s) 1060 permit a user to enter data and commands into the processor 1020. For example, the input device(s) 1060 may be implemented by a keyboard, a mouse, a touch-sensitive display, a track pad, a track ball, an isopoint, and/or a voice recognition system.

One or more output devices 1070 are also connected to the interface circuit 1050. For example, the output device(s) 1070 may be implemented by display devices (e.g., a light emitting display (LED), a liquid crystal display (LCD), a cathode ray tube (CRT) display, a printer and/or speakers). The interface circuit 1050, thus, typically includes, among other things, a graphics driver card.

The processor system 1000 also includes one or more mass storage devices 1080 to store software and data. Examples of such mass storage device(s) 1080 include floppy disks and drives, hard disk drives, compact disks and drives, and digital versatile disks (DVD) and drives.

The interface circuit 1050 also includes a communication device such as a modem or a network interface card to facilitate exchange of data with external computers via a network. The communication link between the processor system 1000 and the network may be any type of network connection such as an Ethernet connection, a digital subscriber line (DSL), a telephone line, a cellular telephone system, a coaxial cable, etc.

Access to the input device(s) 1060, the output device(s) 1070, the mass storage device(s) 1080 and/or the network is typically controlled by the I/O controller 1014 in a conventional manner. In particular, the I/O controller 1014 performs functions that enable the processor 1020 to communicate with the input device(s) 1060, the output device(s) 1070, the mass storage device(s) 1080 and/or the network via the bus 1040 and the interface circuit 1050.

While the components shown in FIG. 4 are depicted as separate blocks within the processor system 1000, the functions performed by some of these blocks may be integrated within a single semiconductor circuit or may be implemented using two or more separate integrated circuits. For example, although the I/O controller 1014, the volatile memory controller 1036, and the non-volatile memory controllers 1038 are depicted as separate blocks, persons of ordinary skill in the art will readily appreciate that the I/O controller 1014, the volatile memory controller 1036, and the non-volatile memory controllers 1038 may be integrated within a single semiconductor circuit.

Although certain example methods, apparatus, and articles of manufacture have been described herein, the scope of coverage of this patent is not limited thereto. On the contrary, this patent covers all methods, apparatus, and articles of manufacture fairly falling within the scope of the appended claims either literally or under the doctrine of equivalents.

1. A method comprising:
generating an interrupt weighted average (IWA) for each of a plurality of processors based on interrupt dispatch information associated with the plurality of processors; and
identifying a target processor from the plurality of processors based on the IWAs to dispatch an interrupt.

2. A method as defined in claim 1, wherein generating the IWA for each of the plurality of processors based on the interrupt dispatch information associated with the plurality of processors comprises generating the IWA for each of the plurality of processors based on at least one of a processor interrupt service age level, a processor interrupt loading history level, and a processor interrupt availability level.

3. A method as defined in claim 1, wherein generating the IWA for each of the plurality of processors based on the interrupt dispatch information associated with the plurality of processors comprises identifying a weight associated with at least one of a processor interrupt service age level, a processor interrupt loading history level, and a processor interrupt availability level.

4. A method as defined in claim 1, wherein generating the IWA for each of the plurality of processors based on the interrupt dispatch information associated with the plurality of processors comprises storing a weight of one or more interrupt load balancing parameters, and calculating the IWA for each of the plurality of processors based the stored weight of the one or more interrupt load balancing parameters.

5. A method as defined in claim 1, wherein identifying the target processor from the plurality of processors based on the IWAs to dispatch the interrupt comprises identifying a processor associated with the highest IWA.

6. A method as defined in claim 1, wherein identifying the target processor from the plurality of processors based on the IWAs to dispatch the interrupt comprises identifying the target processor from the plurality of processors based on the IWAs to dispatch one of a hardware interrupt and a software interrupt.

7. A method as defined in claim 1, further comprising generating an interrupt message to send to the target processor.

8. A machine readable medium storing instructions, which when executed, cause a machine to:
generate an interrupt weighted average (IWA) for each of a plurality of processors based on interrupt dispatch information associated with the plurality of processors; and
identify a target processor from the plurality of processors based on the IWAs to dispatch an interrupt.

9. A machine readable medium as defined in claim 8, wherein the instructions, when executed, cause the machine to generate the IWA for each of the plurality of processors based on the interrupt dispatch information associated with the plurality of processors by generating the IWA for each of the plurality of processors based on at least one of a processor identifier, a processor interrupt service age level, a processor interrupt loading history level, and a processor interrupt availability level.

10. A machine readable medium as defined in claim 8, wherein the instructions, when executed, cause the machine to generate the IWA for each of the plurality of processors based on the interrupt dispatch information associated with the plurality of processors by identifying a weight associated with at least one of a processor interrupt service age level, a processor interrupt loading history level, and a processor interrupt availability level.

11. A machine readable medium as defined in claim 8, wherein the instructions, when executed, cause the machine to identify the target processor from the plurality of processors based on the IWAs to dispatch the interrupt by identifying a processor associated with the highest IWA.

12. A machine readable medium as defined in claim 8, wherein the instructions, when executed, cause the machine to identify the target processor from the plurality of processors based on the IWAs to dispatch the interrupt by identifying the target processor from the plurality of processors to dispatch one of a hardware interrupt and a software interrupt.

13. A machine readable medium as defined in claim 8, wherein the instructions, which when executed, cause the machine to generate an interrupt message to send to the target processor.

14. A machine readable medium as defined in claim 8, wherein the machine readable medium comprises one of a programmable gate array, application specific integrated circuit, erasable programmable read only memory, read only memory, random access memory, magnetic media, and optical media.

15. An apparatus comprising:
an interrupt load balancing policy register (ILBPR) to store one or more weights corresponding to one or more interrupt load balancing parameters;
a plurality of target processor control registers (TPCRS) to store the interrupt dispatch information associated with a plurality of processors;
a weighted average generator to generate an interrupt weighted average (IWA) for each of the plurality of processors based on the weight corresponding to the one or more interrupt load balancing parameters and the interrupt dispatch information associated with the plurality of processors; and
a target processor selector to identify a target processor from the plurality of processors based on the IWAs to dispatch an interrupt.

16. An apparatus as defined in claim 15, wherein the weight corresponding to one or more interrupt load balancing parameters comprises at least one of a processor interrupt service age weight, a processor interrupt loading history weight, and a processor interrupt availability weight.

17. An apparatus as defined in claim 15, wherein the interrupt dispatch information comprises at least one of a processor identifier, a processor interrupt service age level, a processor interrupt loading history level, and a processor interrupt availability level.

18. An apparatus as defined in claim 15, wherein the target processor comprises a processor associated with the highest IWA from the plurality of processors.

19. An apparatus as defined in claim 15, wherein the target processor selector generates an interrupt message to send to the target processor.

20. An apparatus as defined in claim 15, wherein the interrupt comprises one of a hardware interrupt and a software interrupt.

21. A processor system comprising:
an input/output controller programmed to request an interrupt; and
a multi-processor programmable interrupt controller (MPIC) programmed to generate an interrupt weighted average (IWA) for each of a plurality of processors based on interrupt dispatch information associated with the plurality of processors, and to identify a target processor from the plurality of processors based on the IWAs to dispatch the interrupt request.

22. A processor system as defined in claim 21, wherein the MPIC is programmed to generate the IWA for each of the plurality of processors based on at least one of a processor identifier, a processor interrupt service age level, a processor interrupt loading history level, and a processor interrupt availability level.

23. A processor system as defined in claim 21, wherein the MPIC is programmed to store weight of the interrupt dispatch information, and to calculate the IWA for each of the plurality of processors based the stored weight of the interrupt dispatch information.

24. A processor system as defined in claim 21, wherein the MPIC is programmed to identify a weight associated with at least one of a processor interrupt service age level, a processor interrupt loading history level, and a processor interrupt availability level corresponding to the plurality of processors.

25. A processor system as defined in claim 21, wherein the MPIC is programmed to identify a processor associated with the highest IWA.

26. A processor system as defined in claim 21, wherein the MPIC is programmed to generate an interrupt message to send to the target processor.

27. A processor system as defined in claim 21, wherein the interrupt comprises one of a hardware interrupt and a software interrupt.

28. A method comprising:
determining values for a plurality of interrupt load balancing parameters for each of a plurality of processors;
applying a load balancing policy to the values for the plurality of interrupt load balancing parameters to form a plurality of values indicative of an interrupt-related performance of each of the plurality of processors; and
identifying one of the plurality of processors as a target processor to receive an interrupt based on the values indicative of the interrupt-related performance of each of the plurality of processors.

29. A method as defined in claim 28, wherein determining values for the plurality of interrupt load balancing parameters for each of the plurality of processors comprises determine values for at least one of a processor interrupt service age parameter, a processor interrupt loading history parameter, and a processor interrupt availability parameter.

30. A method as defined in claim 28, wherein applying the load balancing policy to the values for the plurality of interrupt load balancing parameters to form the plurality of values indicative of the interrupt-related performance of each of the plurality of processors comprises applying an interrupt weighted average to each of the values for at least one of a processor interrupt service age parameter, a processor interrupt loading history parameter, and a processor interrupt availability parameter.
